(19) United States
(12) Patent Application Publication
(10) Pub. No.: US 2010/0040105 A1
(43) Pub. Date: Feb. 18, 2010

(54) HIGH REPETITION-RATE, ALL LASER DIODE-PUMPED EXTREME ULTRAVIOLET/SOFT X-RAY LASER AND PUMP SYSTEM

(75) Inventors: Jorge J. Rocca, Fort Collins, CO (US); Bradley M. Luther, Fort Collins, CO (US); Brendan A. Reagan, Fort Collins, CO (US); Federico J.A. Furch, Fort Collins, CO (US)

Correspondence Address: COCHRAN FREUND & YOUNG LLC, 2026 CARIBOU DR, SUITE 201, FORT COLLINS, CO, 80525, US

(73) Assignee: XUV, Inc., Fort Collins, CO (US)

(21) Appl. No.: 12/542,663

(22) Filed: Aug. 17, 2009

Related U.S. Application Data
(60) Provisional application No. 61/089,158, filed on Aug. 15, 2008.

(51) Int. Cl. H01S 3/0941

(52) U.S. Cl. 372/75

(57) ABSTRACT

An extreme ultraviolet/soft x-ray laser driven by a compact solid-state chirped pulse amplification laser system entirely pumped by laser diodes is described. The solid-state pump laser generates compressed pulses of sub-10 ps duration with energy greater than 1 J at a chosen repetition rate in a cryogenically cooled Yb:YAG system. Lasing in the 18.9 nm line of Ni-like Mo was observed. The diode-pumped laser has the potential to greatly increase the repetition rate and average power of lasers having a variety of EUV/SXR wavelengths on a significantly smaller footprint.

### RELATED CASES

The present patent application claims the benefit of Provisional Patent Application Ser. No. 61/089,158 filed on 15 Aug. 2008 entitled: “Compact High Repetition EUV Laser” by Jorge J. Rocca et al., the disclosure and teachings of which are hereby incorporated by reference herein.

### STATEMENT REGARDING FEDERAL RIGHTS

This invention was made with government support under NSF Award Number EEC-0310717 from the Engineering Research Centers Program of the National Science Foundation to the NSF Center for Extreme Ultraviolet Science and Technology. The government has certain rights in the invention.

### FIELD OF THE INVENTION

The present invention relates generally to extreme ultraviolet/soft x-ray lasers and, more particularly, to an all-diode-pumped laser apparatus effective for pumping gain-saturated soft x-ray lasers, and other uses.

### BACKGROUND OF THE INVENTION

Prolonged repetitive operation of pulsed lasers at optical wavelengths has been available for several decades and has made possible the implementation of numerous applications requiring intense pulses of coherent infrared, visible, and ultraviolet light. To extend and develop these applications at shorter wavelengths, the development of compact, high repetition-rate sources with high average power is required. Extreme ultraviolet/soft x-ray (EUV/SXR) lasers are attractive sources since they produce higher per pulse energies than other techniques of producing coherent EUV/SXR light, such as high-order harmonic generation. Typical applications include high resolution microscopy, metrology, nano-patterning, and photochemistry.

The laser pump energy required to obtain gain-saturated operation of EUV/SXR lasers has been significantly reduced by directing the picosecond pump pulse at a grazing angle of incidence into a pre-created plasma [See, e.g., R. Keenan et al. “High repetition rate grazing incidence pumped X-ray laser operating at 18.9 nm,” Phys. Rev. Lett. 94, art. 103901, (2005); B. M. Luther et al. “Saturated high-repetition-rate 18.9-nm tabletop laser in nickel like molybdenum,” Opt. Lett. 30, 165-167 (2005); Y. Wang et al. “Demonstration of saturated high repetition rate tabletop soft x-ray lasers at wavelengths down to 13.9 nm and gain down to 10.9 nm”, Phys. Rev. A 72, Art. #053807, (2005); J. J. Rocca et al. “Saturated 13.2 nm high-repetition-rate laser in nickel like cadmium”, Opt. Lett. 30, 2581-2583 (2005); D. Alessi et al. “High repetition rate operation of saturated table-top soft x-ray lasers in transitions of neon-like ions near 30 nm,” Opt. Express 13, 2093-2098 (2005); and M. A. Larotonda et al. “Characteristics of a saturated 18.9-nm tabletop laser operating at 5-Hz repetition rate”, IEEE J. Sel. Top. Quantum Electron., 10, 1363-1367 (2004).], and the use of picosecond-duration pump laser pulses with energies up to 1 J impinging at grazing incidence angles between 14° and 23° has resulted in gain-saturated laser emission for transitions of Ni-like ions [See, e.g., R. Keenan et al., supra; B. M. Luther et al., supra; Y. Wang et al., supra; J. J. Rocca et al., supra, and U.S. Pat. No. 7,308,007 for “Increased Laser Output Energy And Average Power At Wavelengths Below 35 NM” which issued to Jorge J. Rocca et al. on Dec. 11, 2007, the disclosure and teachings of which patent are hereby incorporated by reference herein.], and Ne-like ions [See, e.g., D. Alessi et al., supra.] at wavelengths as short as 13.2 nm for Ni-like Cd. However, these systems are limited in repetition rate to typically 5-10 Hz, and are inefficient.

An infrared laser beam is generated by exciting Nd-doped laser material using flashlamps. Flashlamp heating of the pump laser gain media is known to limit the repetition rate of such lasers. The Nd-doped laser material emits an infrared laser beam which is converted into green light in a doubling crystal. Subsequently, the green light is used to pump a Ti:sapphire crystal that produces an approximately 800 nm wavelength beam that is used to heat a plasma that generates the EUV/SXR laser beam. Alternatively, other flashlamp pumped systems, such as Nd-glass-based systems, can be used to directly heat the plasma. In any case, the inefficient flashlamp excitation of these pump lasers limits the repetition rate, and makes the system large (typically occupying several standard optical tables), complex, and costly.

The widespread use of EUV/SXR lasers in applications requires more compact devices capable of operating at higher repetition rates with high average power. Laser diode-pumped solid state laser systems can be made more compact than equivalent flashlamp-pumped systems. Moreover, the small quantum defect of Yb doped materials and the higher pumping efficiency that results from pumping with a narrow bandwidth source having a wavelength that matches an absorption band of the gain material allows operation at increased repetition rates. Diode-pumped, chirped pulse amplification (CPA) systems based on Yb:YAG have been demonstrated. However, sub-10 ps lasers systems have not yet reached the energy necessary to efficiently pump soft x-ray lasers.

### SUMMARY OF THE INVENTION

Accordingly, it is an object of embodiments of the present invention to provide an all laser diode-pumped source effective for pumping EUV/SXR lasers, among other uses.

It is also an object of the present invention to provide an all laser diode-pumped source effective for generating laser-pumped lasing in the EUV/SXR region of the electromagnetic spectrum from a chosen element.

Another object of the invention is to provide an all laser diode-pumped source effective for pumping EUV/SXR lasers and having a repetition rate of greater than 10 Hz.

Still another object of the invention is to provide a compact, all laser diode-pumped source effective for pumping EUV/SXR lasers.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, the method for generating EUV/SXR laser radiation, hereof, includes: a target comprising selected atoms; a chirped pulse amplification apparatus for generating infrared laser pulses having energy greater than 0.5 J and a pulse duration of less than 20 ps at a chosen repetition rate including: a laser diode-pumped mode-locked laser oscillator for generating sub-picosecond duration infrared pulses; a pulse divider for dividing the output of the laser oscillator into at least two pulses; at least one pulse stretcher for temporally elongating each of the at least two pulses to selected pulse durations; a first laser diode-pumped amplifier for amplifying the stretched pulses; a second laser diode-pumped amplifier for amplifying the amplified, stretched pulses from the first amplifier to a selected energy; and a pulse compressor for reducing the pulse duration of at least one of the pulses exiting the multi-pass amplifier; means for directing the least one amplified stretched pulse onto an exposed surface of the target such that an expanding plasma comprising ions of the selected atoms is generated in the vicinity of the surface; means for directing the at least one amplified pulse having reduced pulse duration into the generated plasma for exciting the plasma, whereby a population inversion in the ions of the plasma is created effective for generating EUV/SXR laser radiation.

In another aspect of the present invention and in accordance with its objects and purposes, the chirped pulse amplification apparatus for generating infrared laser pulses having energy greater than 0.5 J and a pulse duration of less than 20 ps at a chosen repetition rate, hereof, includes: a laser diode-pumped mode-locked laser oscillator for generating sub-picosecond duration infrared pulses; at least one pulse stretcher for temporally elongating the infrared pulses to selected pulse durations; a first laser diode-pumped amplifier having a gain medium chosen from Yb:YAG, Yb:YLF, Yb:S-FAP, Yb:GdCOB, Yb:KYW, Yb:KGW, and Yb:glass, cryogenically cooled to a temperature such that sub-20 ps pulses are generated, for amplifying the stretched pulses; a second laser diode-pumped amplifier having a Yb:YAG gain medium cryogenically cooled to a temperature such that sub-20 ps pulses are generated, for amplifying the amplified, stretched pulses from the first amplifier to a selected energy; and a pulse compressor for reducing the pulse duration of at least one of the pulses exiting the multi-pass amplifier.

In still another aspect of the present invention and in accordance with its objects and purposes, the method for generating EUV/SXR laser radiation, hereof, includes the steps of: generating infrared laser pulses having energy greater than 0.5 J and a pulse duration of less than 20 ps at a chosen repetition rate using a chirped pulse amplification apparatus comprising: a laser diode-pumped mode-locked laser oscillator for generating sub-picosecond duration infrared pulses; a pulse divider for dividing the output of the laser oscillator into at least two pulses; at least one pulse stretcher for temporally elongating each of the at least two pulses to selected pulse durations; a first laser diode-pumped amplifier for amplifying the stretched pulses; a second laser diode-pumped amplifier for amplifying the amplified, stretched pulses from the first amplifier to a selected energy; and a pulse compressor for reducing the pulse duration of at least one of the pulses exiting the multi-pass amplifier; directing the least one amplified stretched pulse onto an exposed surface of a target comprising selected atoms such that an expanding plasma comprising ions of the selected atoms is generated in the vicinity of the surface; directing the at least one amplified pulse having reduced pulse duration into the generated plasma for exciting the plasma, whereby a population inversion in the ions of the plasma is created effective for generating EUV/SXR laser radiation.

In yet another aspect of the present invention and in accordance with its objects and purposes, the method for generating infrared laser pulses having energy greater than 0.5 J and a pulse duration of less than 20 ps at a chosen repetition rate by chirped pulse amplification, hereof, includes the steps of: generating sub-picosecond duration infrared pulses using a laser diode-pumped mode-locked laser oscillator; temporally elongating the infrared pulses to selected pulse durations; amplifying the elongated pulses using a first laser diode-pumped amplifier having a gain medium chosen from Yb:YAG, Yb:YLF, Yb:S-FAP, Yb:GdCOB, Yb:KYW, Yb:KGW, and Yb:glass, cryogenically cooled to a temperature such that sub-20 ps pulses are generated; amplifying the amplified, stretched pulses from the first amplifier to a selected energy using a second laser diode-pumped amplifier having a Yb:YAG gain medium cryogenically cooled to a temperature such that sub-20 ps pulses are generated; and reducing the pulse duration of at least one of the pulses exiting said multi-pass amplifier.

Benefits and advantages of the present invention include, but are not limited to, providing an all diode-pumped EUV/SXR laser having increased repetition rate and average power on a significantly smaller footprint.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a block diagram of an embodiment of the present diode-pumped EUV/SXR laser, illustrating a laser diode-pumped mode-locked oscillator, a pulse divider, a positive and a negative GVD stretcher, a laser diode-pumped regenerative amplifier, a laser diode-pumped amplifier, a pulse compressor, focusing optics, and a target chamber for generating the EUV/SXR radiation.

FIG. 2 is a schematic representation of the laser diode-pumped mode-locked oscillator shown in block form in FIG. 1 hereof.

FIG. 3 is a schematic representation of the laser diode-pumped regenerative amplifier shown in block form in FIG. 1 hereof.

FIG. 4A is a schematic representation of the laser diode-pumped multi-pass amplifier and laser diode stacks shown in block form in FIG. 1 hereof, and FIG. 4B is a schematic representation of the cryogenic cooling system for the laser crystals in the amplifier shown in FIG. 4A hereof.

FIG. 5(a) is a graph of the un-compressed Yb:YAG laser output pulse energy as a function of pump peak power from 2 ms pump pulses, showing a maximum energy of 1.45 J obtained with a peak pump power of 7 kW, while FIG. 5(b) is the hyperbolic secant square fit of the autocorrelation data corresponding to 8.5 ps FWHM pulses.

FIG. 6 is a graph of the on-axis EUV/SXR spectrum of the plasma generated by the diode-pumped laser shown in block form in FIG. 1 hereof, showing lasing in the 18.9 nm laser line of Ni-like Mo.

### DETAILED DESCRIPTION OF THE INVENTION

Briefly, the present invention includes an all-diode-pumped EUV/SXR laser. Lasing was demonstrated in the 18.9 nm line of Ni-like Mo at a repetition rate of 10 Hz using a compact, λ=1.03 μm Chirped Pulse Amplification (CPA) Yb:YAG pump laser, the all-diode-pumped CPA laser system being capable of producing sub-10 ps laser pulses having 1 J energy. The embodiment of the pump laser described herein, with the exception of the pulse compressor, may be disposed on a single 5 ft×12 ft optical table.

EUV/SXR laser radiation may be generated by using an infrared or visible laser having sufficient energy to produce the excitation to produce a transient population inversion between energy levels of a chosen ion specie (nickel-like ions, as an example). This enables high gain for amplification of EUV/SXR photons during a short period of time, typically a few picoseconds. Ultrashort, high energy laser pulses (<10 ps) may be generated using Chirped Pulse Amplification (CPA), wherein laser pulses are created in a mode-locked oscillator at low energy per pulse, with pulse durations that range from a few femtoseconds to a few picoseconds, depending on the particular system. The pulses are stretched in time by providing a controlled “chirp” in the pulse, wherein different frequencies that compose the pulse travel through different paths (having different pathlengths), with the result that the pulse spreads in time. In an embodiment of the present apparatus, a positive group velocity dispersion (GVD) grating stretcher with an Offner telescope and a negative GVD grating stretcher are employed. In the positive GVD stretcher, lower frequencies travel through a shorter path (positive chirp or positive GVD), while in the negative GVD stretcher, higher frequencies travel a shorter path (negative chirp or negative GVD). Pulses exiting the oscillator are divided into three pulses, one pulse is directed to the positive GVD stretcher, the remaining two pulses are directed to the negative GVD stretcher. This is done to provide a sequence of two long pulses (hundreds of picoseconds) for producing and ionizing a plasma (pre-pre pulse and pre-pulse, respectively), and a short pulse to heat or excite the plasma [See, e.g., U.S. Pat. No. 7,308,007, supra.].

After stretching, the pulses may be amplified without reaching high intensities (the intensity is inversely proportional to the time duration of the pulse) that could otherwise distort the pulse through non-linear interactions with optical materials, or damage or destroy the optical components of the system. In a typical CPA system, once the pulses have the required amount of energy, they may be recompressed in a grating compressor (in accordance with an embodiment of the present invention) that reverses the dispersion and compensates for the chirp introduced in the positive GVD stretcher. In the grating compressor the lower frequencies travel a longer path (negative chirp, or negative group velocity dispersion). As a result of this process, at the output of a CPA system, it is possible to obtain high energy, ultrashort laser pulses. In the embodiment of the present apparatus described herein, the positive chirped pulse is compressed while the negative chirped pulses are further stretched in time.

Cryogenic cooling of Yb:YAG significantly reduces the laser linewidth [See, e.g., J. Dong et al., “Dependence of the Yb³⁺ emission cross section and lifetime on temperature and concentration in yttrium aluminum garnet”, J. Opt. Soc. Am. B 20, 1975-1979 (2003).], thereby increasing the stimulated emission cross-section and reducing the saturation fluence, and consequently allowing for more efficient energy extraction. Moreover, cryo-cooling improves the thermal properties of YAG [See, e.g., R. L. Aggarwal et al., “Measurement of thermo-optic properties of Y₃Al₅O₁₂, Lu₃Al₅O₁₂, YAlO₃, LiYF₄, LiLuF₄, BaY₂F₈, KGd(WO₄)₂, and KY(WO₄)₂ laser crystals in the 80-300 K temperature range”, J. Appl. Phys. 98, 103514 (2005)], making it attractive for the development of compact, high repetition-rate laser amplifiers. Although cryogenically cooled Yb:YAG [Y₃Al₅O₁₂] combines desirable spectroscopic and thermal properties that make it an effective material for an all diode-pumped high repetition-rate CPA laser system, other Yb-doped materials, such as YLF [YLiF₄], S-FAP [Sr₅(PO₄)₃F], GdCOB [GdCa₄O(BO₃)₃], KYW [KY(WO₄)₂], KGW [KGd(WO₄)₂], and glass, at room temperature or at cryogenic temperatures may be suitable for all diode-pumped CPA systems that are capable of pumping EUV/SXR lasers, as long as sufficiently broad bandwidth can be maintained for short pulse generation. Further, different materials may be used for different amplifiers when an overlap in the emission bandwidths exists.

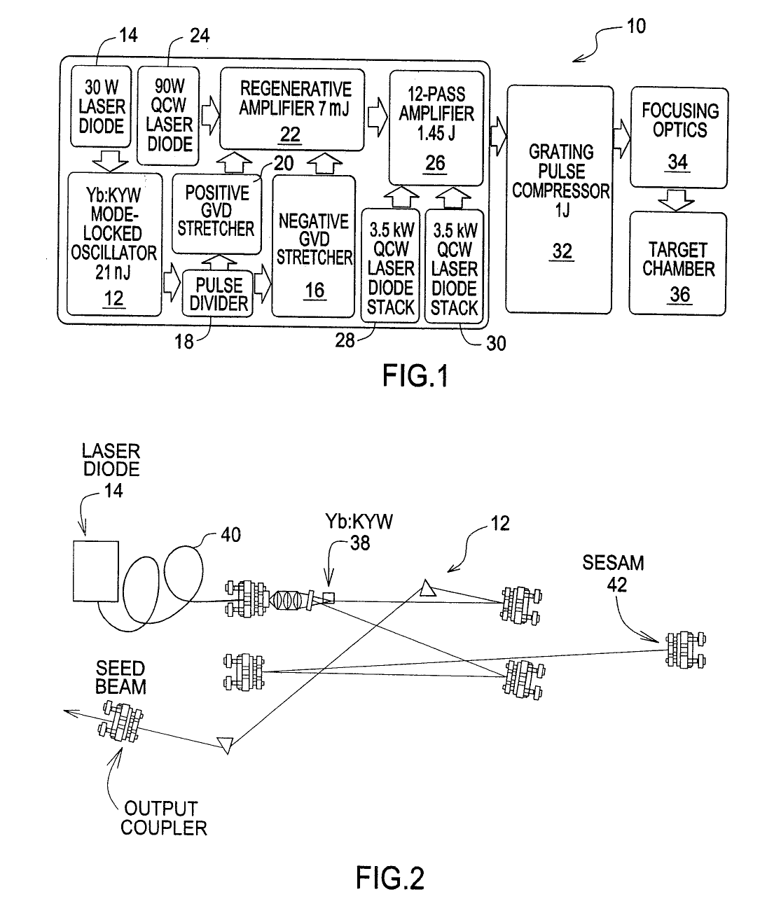

Reference will now be made in detail to the present embodiments of the invention, examples of which are illustrated in the accompanying drawings. In the FIGURES, similar structure will be identified using identical callouts. Turning now to FIG. 1, a block diagram of an embodiment of the present diode-pumped EUV/SXR laser, 10, illustrating passively mode-locked Yb:KYW (potassium-yttrium tungstate doped with ytterbium ions) laser oscillator, 12, pumped by laser diode, 14, negative Group Velocity Dispersion (GVD) stretcher, 16, which receives pulses from laser oscillator 12 as directed by pulse divider, 18, and positive GVD stretcher, 20, which receives pulses from laser oscillator 12, as directed by pulse divider, 18, cryogenically cooled Yb:YAG regenerative amplifier, 22, pumped by laser diode, 24, cryogenically cooled Yb:YAG multi-pass laser amplifier, 26, pumped by laser diodes, 28 and 30, pulse compressor, 32, focusing optics, 34, and target chamber, 36, for generating EUV/SXR radiation [See U.S. Pat. No. 7,308,007, supra.].

After exiting oscillator 12, a pulse is divided into two pulses by a polarizing beamsplitter which is part of pulse divider 18. By adjusting the polarization before the polarizing beamsplitter using a half-waveplate the relative energy in these two pulses can be controlled. One of the pulses is directed to positive dispersion stretcher 20 (this will become the short pulse). The other pulse is further divided into two pulses by a beamsplitter which is part of pulse divider 18, and will become the “pre-pulse” and the “pre-pre-pulse.” To control the relative energy of these two pulses a variable loss is introduced into the pre-pre-pulse line using a half-waveplate and a polarizer which is part of pulse divider 18. The pre-pulse beam is directed through a delay line which is part of pulse divider 18, before being recombined with the pre-pre-pulse beam in another beamsplitter which is part of pulse divider 18, and the two pulses are directed to negative GVD stretcher 16. The two beams exiting the two stretchers are recombined into one beam by a final beamsplitter (not shown in FIG. 1). The three pulses are directed into regenerative amplifier 22. Before the beams are recombined, the pulse that after compression will become the short pulse is directed through a variable delay line (not shown in FIG. 1) that permits the delay between the short pulse and the two pre-pulses to be adjusted to a selected value.

By generating pulses in this manner ensures that the three pulses are collinear after amplification in regenerative amplifier 22. Any misalignment between pulses before entering regenerative amplifier 22 affects only the coupling efficiency into the amplifier, and not the collinearity thereof, which is advantageous since the generation of EUV/SXR lasing requires good spatial overlap of the three pulses.

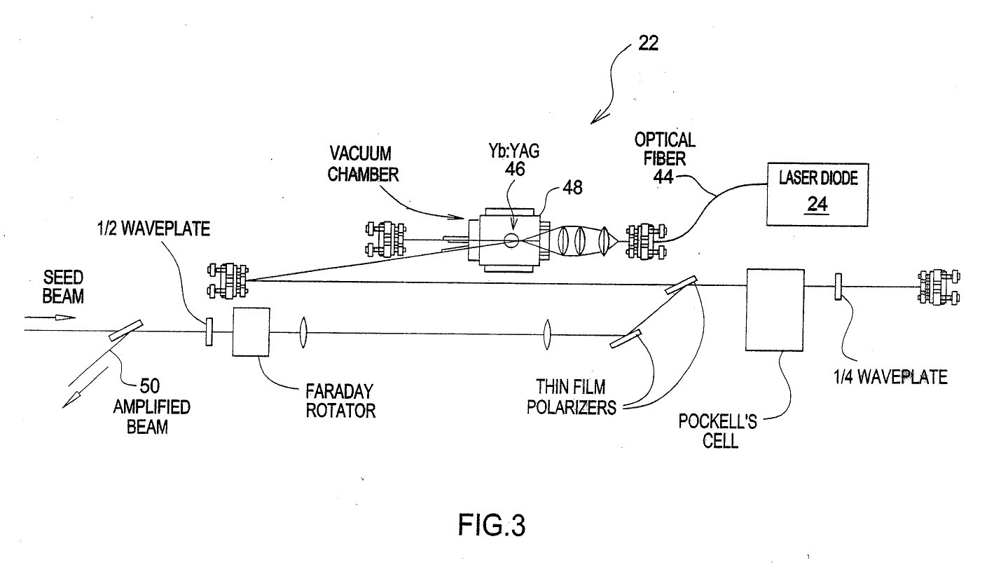

FIG. 2 is a schematic representation of passively mode-locked Yb:KYW, 38, laser oscillator, 12, pumped by 30W laser diode, 14, coupled to optical fiber, 40. SESAM (Semiconductor Saturable Absorber Mirror), 42, permits passive mode-locking of the oscillator.

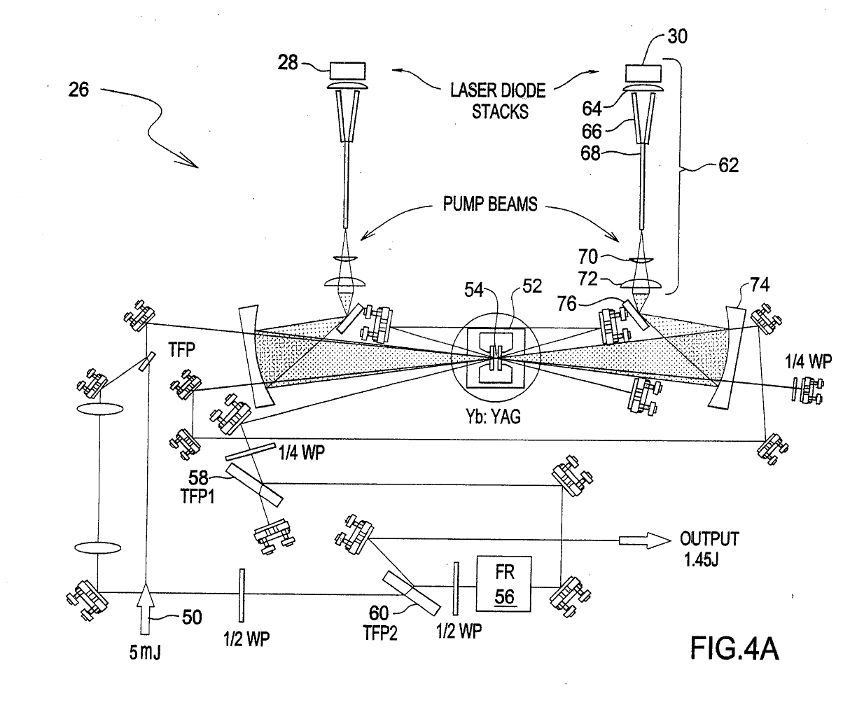

FIG. 3 is a schematic representation of cryogenically cooled Yb:YAG regenerative amplifier, 22, pumped by laser diode, 24, coupled to optical fiber 44. As Yb:YAG crystal, 46, is cryogenically cooled, 48, it is kept under vacuum (not shown in FIG. 3) to avoid water condensation on the crystal faces.

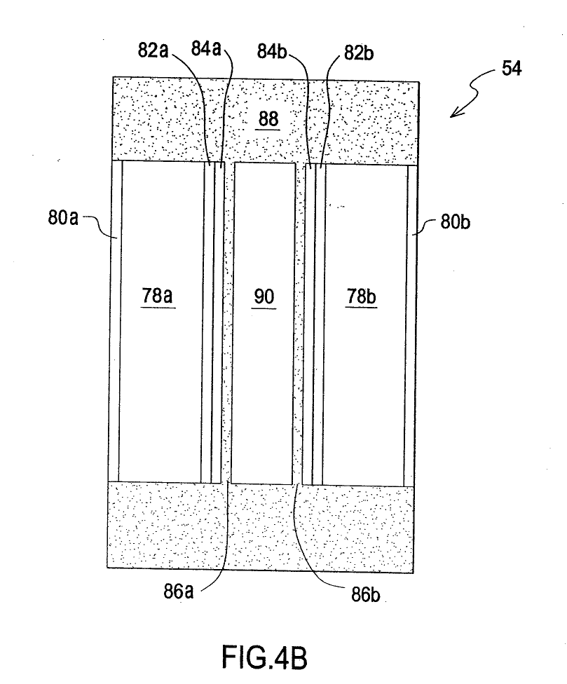

FIG. 4A is a schematic representation of the multi-pass amplifier, 26, pumped by laser diodes 28 and 30 shown in block form in FIG. 1 hereof, for further amplification of the pulses exiting the regenerative amplifier, while FIG. 4B is a schematic representation of the cryogenic cooling system for the laser crystal.

Beam, 50, from regenerative amplifier 22 makes four passes through cryogenically cooled, 52, gain medium, 54, changing the polarization from p to s after the second pass. The beam is then expanded, directed through Faraday rotator (FR), 56, and further amplified in an additional four passes. Subsequently the polarization changes from s to p, the beam is directed through Thin Film Polarizer (TFP1), 58, and is sent back on itself to make four additional passes. The beam changes polarization back to s, and is ejected by TFP2, 60.

Design of high energy, diode-pumped, solid-state laser systems involves coupling of light from stacks of laser diodes into a laser crystal. The emitted light from high power laser diode stacks is non-uniform, has a large initial size, and has high divergence which is different for different axes. FIG. 4A shows optical system, 62, for diode stack 30, with an identical system for diode stack 28, for accommodating this combination of parameters for solid-state lasers by homogenizing the light emitted from the laser diodes, shaping the beam into a circular spot, and coupling the light into the laser crystal. With this system, laser seed pulse 50 amplified in laser crystal 54 may enter and exit the crystal without requiring holes in the center of the pump optics and laser diodes.

Laser crystal 54 may be a 30 mm×30 mm×5.5 mm thick Yb:YAG crystal having 2%-at Yb doping. The front surface has an antireflective dielectric coating for both the laser diode (940 nm) and the laser (1030 nm) wavelengths. The back surface has a highly reflective coating for both wavelengths.

Laser diode stack 30 may be a vertical stack of 25 laser diode bars emitting up to 3.5 kW at 940 nm. The fast axis (vertical axis in FIG. 4A) is lensed to reduce the divergence to approximately 0.5°. Positive spherical or cylindrical lens, 64, focuses the laser diode light in the vertical direction. Two-dimensional concentrator, 66, may include two mirrors that concentrate the laser diode light in the horizontal direction. Light homogenizing rod, 68, shapes and confines the laser diode radiation into a uniform and circular spot suitable for end-pumping solid-state lasers by multiple total internal reflections on the radial surfaces of the rod. The present “duct” system is effective for coupling the laser diode light into rod 68. An advantage of this “duct” system is that the angle and position of the duct may be optimized in situ.

Light exiting rod 68 is imaged onto laser crystal 54. Lens, 70, lens, 72, and spherical concave mirror, 74, together form an imaging system that images the pump light exiting the end of the rod onto the laser crystal 54. Flat mirror, 76, is used for folding laser diode optical system 62.

Clearly, other optical systems may be envisioned for imaging the end of rod 68 onto laser medium 54.

FIG. 4B shows laser medium 54 of multi-pass laser amplifier 26 in greater detail. Crystal 54 includes two Yb:YAG crystals mounted on single, liquid nitrogen cooler 52. The crystals are used in an “active-mirror” configuration that allows for efficient heat removal with small radial thermal gradients, and is compact. As stated hereinabove, laser medium 54 includes two 30 mm×30 mm×5.5 mm Yb 2%-at YAG crystals, 78a and 78b having dielectric, anti-reflection coatings, 80a and 80b, effective at both the laser diode (940 nm) and laser (1030 nm) wavelengths, and dielectric highly reflective coatings, 82a and 82b, effective at both the laser diode (940 nm) and laser (1030nm) wavelengths. Thin layers of Indium foil, 84a and 84b, are effective for thermal coupling between the crystals and surfaces, 86a and 86b of copper holder, 88. Liquid nitrogen, 90, is flowed through holder 88. The entire crystal assembly is disposed inside of a vacuum chamber (not shown in FIG. 4B).

Cryogenic cooling of the crystal greatly increases the heat conductivity of the Yb-doped laser material, allowing for increased heat dissipation that in turn allows for higher repetition rate operation and a reduction of undesirable thermal lensing. However, for some Yb-doped laser materials, cryogenic cooling to liquid nitrogen temperatures excessively narrows the laser linewidth, thereby increasing the pulsewidth of the shortest pulses that can be obtained. This increased pulsewidth may preclude efficient excitation of the plasma that generates the EUV/SXR laser beam, and may even preclude EUV/SXR laser generation altogether. In an embodiment of the present invention, laser medium 46 was adjusted to a cryogenic temperature effective for obtaining a sufficiently broad laser linewidth to permit generation of sufficiently short pump laser pulses (for example, 2-15 ps duration) by combining a helium cryostat cooling system with a controlled electrical heater, as an example.

In operation, Yb:KYW oscillator 12 generates 300 fs pulses at a repetition rate of 57 MHz with an average power of 1.2 W when pumped by 30 W, 980 nm fiber-coupled laser diode 14 and is mode-locked utilizing semiconductor saturable absorber mirror 42 having 2% unsaturated absorption loss. The output of the oscillator is divided to generate a sequence of three amplified 1.03 μm laser pulses that are used to generate EUV/soft x-ray lasing in accordance with the teachings of U.S. Pat. No. 7,308,007, supra. The first and second pulses are sent through negative GVD stretcher 16, while the third pulse is sent through a standard positive GVD stretcher 20. After amplification by regenerative amplifier 22, the duration of the first two pulses is 160 ps and the duration of the third pulse is 200 ps. The relative energies of the pulses and the delays between them are adjusted, the pulses are recombined, and then directed to regenerative amplifier 22, multi-pass amplifier 26 and vacuum compressor (a negative GVD grating pair) 32. This grating pair further stretches the first two pulses while compressing the final heating pulse. This permits a sequence of two long pulses for plasma creation, followed by a short, plasma heating pulse to be generated. Furthermore, since the alignment of the three beams is determined by the cavity of regenerative amplifier 22, as stated hereinabove, the spatial overlap of the three pulses is ensured by design.

Regenerative amplifier 22 increases the combined pulse energy to 7 mJ using a 2 mm thick 5 at. % Yb:YAG crystal 46 that is cryogenically cooled using a closed cycle helium cryostat 48. The crystal temperature is tuned to about 100 K utilizing an electrical heater to increase the bandwidth of the amplified pulses. Regenerative amplifier 22 is pumped by 90 W fiber-coupled 44 laser diode 24 emitting at a wavelength of 940 nm. The diode is modulated to produce 1.2 ms pulses that are focused into an approximately 700 μm diameter spot on crystal 46. The repetition rate of the amplifier was varied between 10 and 100 Hz with essentially no reduction in energy or beam quality. In another embodiment of the apparatus of the present invention, a second multi-pass amplifier might be substituted for regenerative amplifier 22 (not shown in the FIGURES). In such a configuration, the laser cavity in the regenerative amplified might be replaced by a set of mirrors configured to permit multiple passes of selected pulses from the oscillator though the gain medium.

The energy is increased to the Joule-level in compact multi-pass laser amplifier 26 having a gain medium 54 divided into two 5.5 mm thick 2 at. % Yb:YAG crystals in an active-mirror configuration. Off-axis spontaneous emission is absorbed by a Cr:YAG cladding eliminating parasitic lasing (not shown in the FIGURES). The crystals are mounted on the opposite faces of a cold finger that is cooled by liquid nitrogen in an evacuated chamber. Each of the crystals is pumped by 3.5 kW pulses of 2 ms duration produced by a stack of 940 nm laser diodes. Laser diode 28, 30 outputs are shaped to illuminate a circular region on each of Yb:YAG laser crystals 78a and 78b. The light exiting regenerative amplifier 22 makes up to 12 passes through amplifier 26. The beam diameter is increased to approximately 8 mm to make the initial four passes through the amplifier (two on each crystal) passing through small holes in the large mirrors used to focus the pump beams onto the crystals. After these initial four passes the amplified pulses reach about 100 mJ. Subsequently, the beam is expanded to match the size of the pump beams and is directed eight additional times through the gain media (four times through each crystal) using waveplates and polarizers.

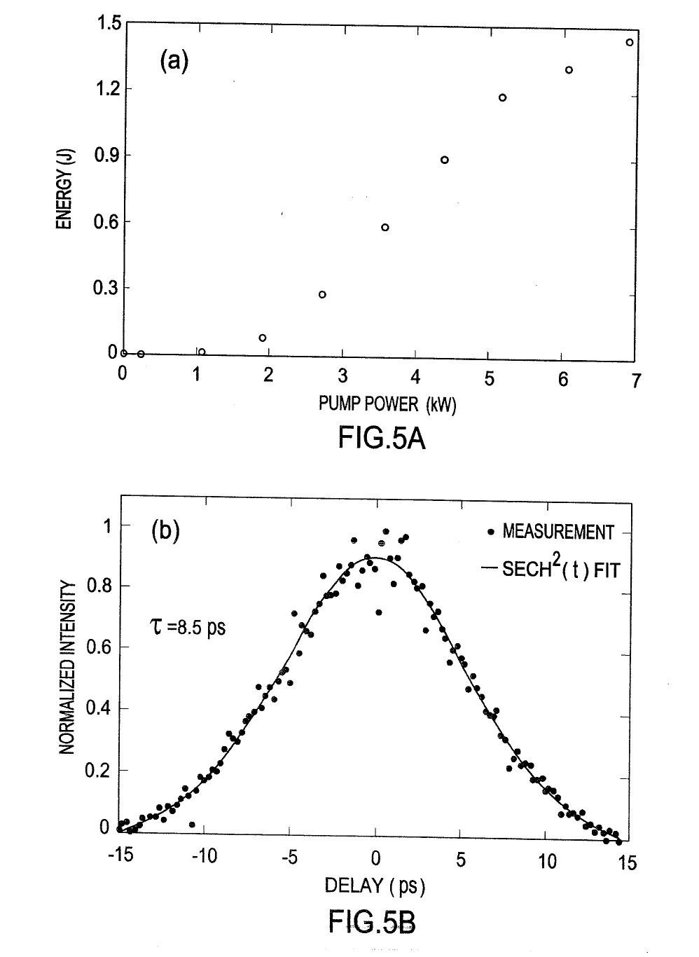

FIG. 5a is a graph of the energy of the pulses exiting the amplifier plotted as a function of diode pump power. A maximum energy of 1.45 J was measured at 10 Hz repetition rate. Higher repetition rates may be obtained by optimizing the pump pulse temporal shape, and by improved thermal management. Further amplification of the pulses to obtain yet higher energy may be achieved by injecting the output of multi-pass amplifier 26 into another laser diode-pumped multi-pass amplifier (not shown in the FIGURES), which may be implemented in accordance with the teachings of the present invention. Advantageously, the number of passes that the beam undergoes through the gain medium of such additional amplifier may be reduced and the diameter of the beam may be expanded to reduce the irradiation fluence to avoid non-linear effects and damage to the optical components.

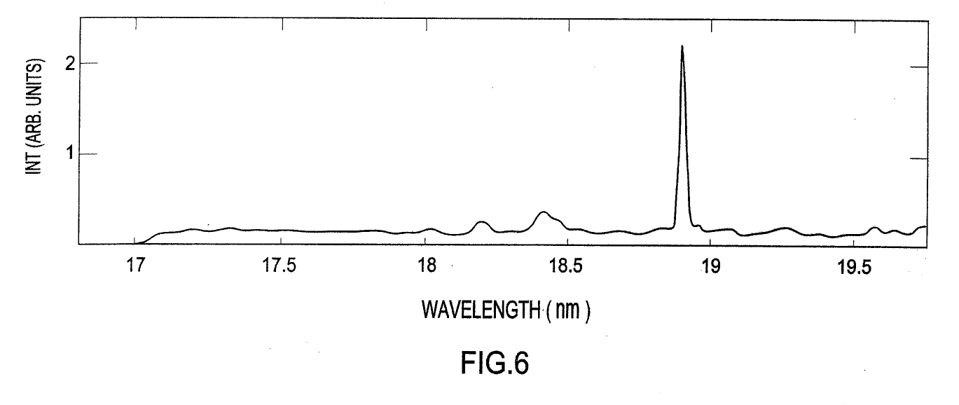

Amplified pulses were directed into 70% efficient vacuum compressor 32 including dielectric multilayer gratings. The short pulse was compressed to 8.5 ps FWHM (sech² pulses) as shown in the autocorrelation trace in FIG. 5b, while the pre-pulses are further stretched to 350 ps FWHM. The collinear pulses were focused at a grazing incidence angle of 29° into a 4 mm-wide polished Mo target 36 to form a 3.5 mm FWHM long line having a width of approximately 35 μm FWHM [See U.S. Pat. No. 7,308,007, supra.]. The axial EUV/SXR plasma emission was analyzed using a 1200 l/mm variable space grating and a back-thinned CCD. Two 0.3 μm thick aluminum filters were used to block the visible light emitted by the plasma. FIG. 6 shows a single shot, on-axis spectra showing lasing in the 18.9 nm line of Ni-like Mo, obtained with a total pump energy on target of about 940 mJ (10 mJ and 320 mJ pre-pulses separated by about 4 ns, followed by a 620 mJ short pulse after 800 ps). The non-optimized EUV/SXR laser output energy was estimated to be 50 nJ. Improvement of the line focus quality may increase the output energy. Other EUV/SXR laser wavelengths in the range between 5 nm and 40 nm may be generated by changing the target material. For example, lasing at 13.2 nm can be achieved using a Cd target, and lasing at 13.9 nm can be achieved using an Ag target.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An apparatus for generating extreme ultraviolet/soft x-ray laser radiation comprising in combination:
a target comprising selected atoms;
a chirped pulse amplification apparatus for generating infrared laser pulses having energy greater than 0.5 J and a pulse duration of less than 20 ps at a chosen repetition rate comprising:
a laser diode-pumped mode-locked laser oscillator for generating sub-picosecond duration infrared pulses;
a pulse divider for dividing the output of said laser oscillator into at least two pulses;
at least one pulse stretcher for temporally elongating each of the at least two pulses to selected pulse durations;
a first laser diode-pumped amplifier for amplifying the stretched pulses;
a second laser diode-pumped amplifier for amplifying the amplified, stretched pulses from said first amplifier to a selected energy; and
a pulse compressor for reducing the pulse duration of at least one of the pulses exiting said multi-pass amplifier;
means for directing the at least one amplified stretched pulse onto an exposed surface of said target such that an expanding plasma comprising ions of the selected atoms is generated in the vicinity of the surface;
means for directing the at least one amplified pulse having reduced pulse duration into the generated plasma for exciting the plasma, whereby a population inversion in the ions of the plasma is created effective for generating extreme ultraviolet/soft x-ray laser radiation.

2. The apparatus of claim 1, wherein said laser diode-pumped oscillator comprises a Yb:KYW oscillator.

3. The apparatus of claim 1, wherein said first laser diode-pumped amplifier comprises a laser diode-pumped, regenerative amplifier having a gain medium chosen from Yb:YAG, Yb:YLF, Yb:S-FAP, Yb:GdCOB, Yb:KYW, Yb:KGW, and Yb:glass.

4. The apparatus of claim 3, wherein the gain medium is cryogenically cooled to a temperature such that sub-20 ps pulses are generated.

5. The apparatus of claim 1, wherein said first laser diode-pumped amplifier comprises a laser diode-pumped, multi-pass amplifier having a gain medium chosen from Yb:YAG, Yb:YLF, Yb:S-FAP, Yb:GdCOB, Yb:KYW, Yb:KGW, and Yb:glass.

6. The apparatus of claim 5, wherein the gain medium is cryogenically cooled to a temperature such that sub-20 ps pulses are generated.

7. The apparatus of claim 1, wherein said second laser diode-pumped amplifier comprises a laser diode-pumped, multi-pass amplifier having a gain medium chosen from Yb:YAG, Yb:YLF, Yb:S-FAP, Yb:GdCOB, Yb:KYW, Yb:KGW, and glass.

8. The apparatus of claim 7, wherein the gain medium is cryogenically cooled to a temperature such that sub-20 ps pulses are generated.

9. The apparatus of 1, further comprising a third, laser diode-pumped amplifier for amplifying pulses exiting said second laser diode-pumped amplifier.

10. The apparatus of claim 9, wherein said third laser diode-pumped amplifier comprises a laser diode-pumped, multi-pass amplifier having a gain medium chosen from Yb:YAG, Yb:YLF, Yb:S-FAP, Yb:GdCOB, Yb:KYW, Yb:KGW, and Yb:glass.

11. The apparatus of claim 10, wherein the gain medium is cryogenically cooled to a temperature such that sub-20 ps pulses are generated.

12.The apparatus of claim 1, further comprising a fourth, laser diode-pumped amplifier for amplifying the amplified, stretched pulses from said first amplifier to a selected energy.

13.The apparatus of claim 12, wherein said fourth laser diode-pumped amplifier comprises a laser diode-pumped, multi-pass amplifier having a gain medium chosen from Yb:YAG, Yb:YLF, Yb:S-FAP, Yb:GdCOB, Yb:KYW, Yb:KGW, and Yb:glass.

14.The apparatus of claim 13, wherein the gain medium is cryogenically cooled to a temperature such that sub-20 ps pulses are generated.

15. The apparatus of claim 1, wherein said pulse divider separates the pulses from said laser diode-pumped oscillator into first and second pulses, and a third pulse, wherein the pulses are directed into said stretcher such that a sequence of pulses is generated.

16. The apparatus of claim 15, wherein said pulse stretcher comprises: a positive group velocity dispersion stretcher; and a negative group velocity dispersion stretcher.

17. The apparatus of claim 16, wherein the first and second pulses are directed into said negative group velocity dispersion stretcher, and the third pulse is directed into said positive group velocity dispersion stretcher.

18. The apparatus of claim 1, wherein said pulse compressor comprises a negative group velocity dispersion grating pair such that the time durations of the stretched first and second pulses are further elongated therein, and the time duration of the third pulse is reduced therein.

19. A chirped pulse amplification apparatus for generating infrared laser pulses having energy greater than 0.5 J and a pulse duration of less than 20 ps at a chosen repetition rate comprising:
a laser diode-pumped mode-locked laser oscillator for generating sub-picosecond duration infrared pulses;
a pulse stretcher for temporally elongating the infrared pulses to selected pulse durations;
a first laser diode-pumped amplifier having a gain medium chosen from Yb:YAG, Yb:YLF, Yb:S-FAP, Yb:GdCOB, Yb:KYW, Yb:KGW, and Yb:glass, cryogenically cooled to a temperature such that sub-20 ps pulses are generated, for amplifying the stretched pulses;
a second laser diode-pumped amplifier having a gain medium chosen from Yb:YAG, Yb:YLF, Yb:S-FAP, Yb:GdCOB, Yb:KYW, Yb:KGW, and glass, cryogenically cooled to a temperature such that sub-20 ps pulses are generated, for amplifying the amplified, stretched pulses from said first amplifier to a selected energy; and
a pulse compressor for reducing the pulse duration of the pulses exiting said multi-pass amplifier.

20. The apparatus of claim 19, wherein said laser diode-pumped oscillator comprises a Yb:KYW oscillator.

21. The apparatus of claim 19, wherein said first amplifier comprises a regenerative amplifier.

22. The apparatus of claim 19, wherein said first amplifier comprises a multi-pass amplifier.

23. The apparatus of claim 19, wherein said second amplifier comprises a multi-pass amplifier.

24. The apparatus of 19, further comprising a third, laser diode-pumped amplifier for amplifying pulses exiting said second laser diode-pumped amplifier.

25. The apparatus of claim 24, wherein said third laser diode-pumped amplifier comprises a laser diode-pumped, multi-pass amplifier having a gain medium chosen from Yb:YAG, Yb:YLF, Yb:S-FAP, Yb:GdCOB, Yb:KYW, Yb:KGW, and Yb:glass.

26. The apparatus of claim 25, wherein the gain medium is cryogenically cooled to a temperature such that sub-20 ps pulses are generated.

27. The apparatus of claim 19, further comprising a fourth, laser diode-pumped amplifier for amplifying the amplified, stretched pulses from said first amplifier to a selected energy.

28. The apparatus of claim 27, wherein said fourth laser diode-pumped amplifier comprises a laser diode-pumped, multi-pass amplifier having a gain medium chosen from Yb:YAG, Yb:YLF, Yb:S-FAP, Yb:GdCOB, Yb:KYW, Yb:KGW, and Yb:glass.

29. The apparatus of claim 28, wherein the gain medium is cryogenically cooled to a temperature such that sub-20 ps pulses are generated.

30. A method for generating extreme ultraviolet/soft x-ray laser radiation comprising the steps of:
generating infrared laser pulses having energy greater than 0.5 J and a pulse duration of less than 20 ps at a chosen repetition rate using a chirped pulse amplification apparatus comprising:
a laser diode-pumped mode-locked laser oscillator for generating sub-picosecond duration infrared pulses;
a pulse divider for dividing the output of said laser oscillator into at least two pulses;
at least one pulse stretcher for temporally elongating each of the at least two pulses to selected pulse durations;
a first laser diode-pumped amplifier for amplifying the stretched pulses;
a second laser diode-pumped amplifier for amplifying the amplified, stretched pulses from said first amplifier to a selected energy; and
a pulse compressor for reducing the pulse duration of at least one of the pulses exiting said multi-pass amplifier;
directing the least one amplified stretched pulse onto an exposed surface of a target comprising selected atoms such that an expanding plasma comprising ions of the selected atoms is generated in the vicinity of the surface;
directing the at least one amplified pulse having reduced pulse duration into the generated plasma for exciting the plasma, whereby a population inversion in the ions of the plasma is created effective for generating extreme ultraviolet/soft x-ray laser radiation.

31. A method for generating infrared laser pulses having energy greater than 0.5 J and a pulse duration of less than 20 ps at a chosen repetition rate by chirped pulse amplification comprising the steps of:
generating sub-picosecond duration infrared pulses using a laser diode-pumped mode-locked laser oscillator;
temporally elongating the infrared pulses to selected pulse durations;
amplifying the elongated pulses using a first laser diode-pumped amplifier having a gain medium chosen from Yb:YAG, Yb:YLF, Yb:S-FAP, Yb:GdCOB, Yb:KYW, Yb:KGW, and Yb:glass, cryogenically cooled to a temperature such that sub-20 ps pulses are generated;
amplifying the amplified, stretched pulses from the first amplifier to a selected energy using a second laser diode-pumped amplifier having a gain medium chosen from Yb:YAG, Yb:YLF, Yb:S-FAP, Yb:GdCOB, Yb:KYW, Yb:KGW, and Yb:glass cryogenically cooled to a temperature such that sub-20 ps pulses are generated; and
reducing the pulse duration of at least one of the pulses exiting said multi-pass amplifier.
